(19) United States
(12) Patent Application Publication
(10) Pub. No.: US 2007/0163409 A1
(43) Pub. Date: Jul. 19, 2007

(54) Miter Saw Having Slide Mechanism

(76) Inventors: Tomomasa Nishikawa, Hitachinaka-shi (JP); Kenichi Matsunaga, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/623,766

(22) Filed: Jan. 17, 2007

(30) Foreign Application Priority Data
Jan. 17, 2006 (JP) P2006-008772

(51) Int. Cl. B26D 1/18

(52) U.S. Cl. 83/485; 83/471.3; 83/491

(57) ABSTRACT

A miter saw capable of reducing scattering amount of cutting chips at a terminal phase of cutting operation. The miter saw includes a base section for supporting a workpiece, a cutting section, and a support section for supporting the cutting section. The support section includes a slide support part extending from the base section, and a pivot support part for pivotally movably supporting the cutting section. The cutting section includes a cutting chip inflow part. A guard extends from the slide support part. The guard has a slope portion for guiding cutting chips toward the inflow part. The slope portion is positioned on an extension of an intersection line defined between the base section and a saw blade and is movable in the direction of the intersection line.

### BACKGROUND OF THE INVENTION

The present invention relates to a miter saw, and more particularly, to a miter saw having a slide mechanism.

In a conventional miter saw having a slide mechanism, an exhaust port is provided behind a saw blade so as to allow cutting chips to flow into the port and to be discharged outside through the port. A dust collector, or a dust collector bag, and the like are connected to the exhaust port to collect cutting chips into the dust collector bag. In order to raise dust collection efficiency, laid-open Japanese Utility Model application publication Nos. H3-108401 and H3-112301 disclose a mechanism for moving a guide plate for guiding cutting chips to an exhaust port. The guide plate is provided at a lower part of a miter saw body and has a substantially U-shaped cross-section. The guide plate is pivotally movable. In case a workpiece to be cut has a certain height, the guide plate is elevated in contact with the workpiece.

Laid-open Japanese Patent Application Publication No. H8-323706 discloses a tubular guide member for guiding cutting chips. An inclination angle of the tubular guide member is changeable in frontward/rearward direction of the miter saw body.

However, according to the arrangements disclosed in these publications, cutting chips are discharged outside to an ambient area of the miter saw. In order to solve this problem, laid-open Japanese Patent Application Publication No. H11-170214 discloses a mechanism for positively introducing cutting chips to an exhaust port.

That is, the mechanism includes, as shown in FIG. 5, a cutting chips guide member 121, and a cutting chip guide tool 119 co-operating together so as to direct the cutting chips toward the exhaust port 114a. The guide member 121 is positioned along the scattering direction of the cutting chips.

The cutting chips guide member 121 is fixed to a cutting blade unit 114, and moves together with a saw blade 130, maintaining a close distance from the saw blade 130. The cutting chips guide tool 119 is fixed to a holder (not shown) at a position where the tool 119 does not interfere with the saw blade 130. With this arrangement, a distance between the cutting chip guide tool 119 and the saw blade 130 is changeable during cutting operation.

Provision of the cutting chips guide tool 119 reduces amount of cutting chips dispersed around the ambient area of the miter saw. However, an area extending between the saw blade 130 and the cutting chips guide member 121 is not hermetic. Depending on the relationship of posture between the cutting chips guide member 121 and the saw blade 130 those movable relative to the cutting chips guide tool 119, cutting chips may be discharged outside through a space between the cutting chips guide member 121 and the cutting chips guide tool 119. Particularly, when cutting is about to be finished, cutting chips tends to rush out substantially horizontally from the workpiece and may be easily discharged outside through the space between the cutting chips guide member 121 and the cutting chips guide tool 119. Consequently, an operator become sensitive to changes in such cutting chips blowing amount and feel uncomfortable.

### SUMMARY OF THE INVENTION

It is therefore, an object of the present invention to provide a miter saw capable of reducing an amount of cutting chips discharged particularly during terminal phase of cutting operation.

This and other object of the present invention will be attained by a miter saw including a base section, a cutting section, a support section, and a slope portion. A workpiece is mountable on the base section. The cutting section supports a circular saw blade and defines an inflow part into which cutting chips are to be introduced. The circular saw blade and the base section define an intersection line. The support section is provided to the base section and supports the cutting section. The support section includes a pivot support part and a slide support part. The pivot support part pivotally supports the cutting section for moving the cutting section toward and away from the base section. The slide support part extends from the base section and slidably supports the pivot support part for moving the pivot support part in a direction of the intersection line. The slope portion is positioned between the support section and the circular saw blade and in alignment with the intersection line and is movable in the direction of the intersection line. The slope portion has a deflection surface at a position confrontable with the circular saw blade and configured to direct the cutting chips toward the inflow part.

### BRIEF DESCRIPTION OF THE DRAWINGS

In the drawings;

FIG. 1 is a side view of a miter saw according to an embodiment of the present invention;

FIG. 2 is an enlarged perspective view showing a guard part of the miter saw according to the embodiment of the invention;

FIG. 3 is a schematic side view of the miter saw according to the embodiment of the invention and showing a state in which a cutting section is at a second position;

FIG. 4 is a schematic side view of the miter saw according to the embodiment and showing a state in which the cutting section is positioned between the second and a third positions; and

FIG. 5 is a side view of a conventional miter saw.

### DETAILED DESCRIPTION OF THE PREFERRED EMBODIMENTS

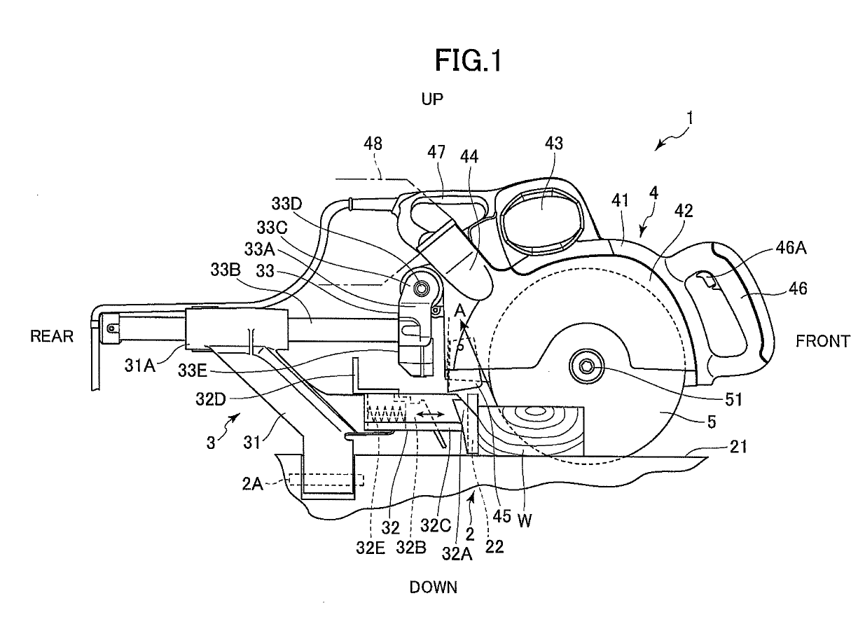

A miter saw according to an embodiment of the present invention will now be described with reference to FIGS. 1 to 4. A miter saw 1 has a slide mechanism and includes mainly a base section 2, a support section 3, and a cutting section 4.

The base section 2 is configured to include an upper face 21 and a pin 2A connecting with the support section 3. The upper face 21 supports a wooden material W as a workpiece to be cut. The pin 2A has its own axis extending in parallel with the upper face 21. One axial side of the pin 2A where the workpiece W is set will be referred to as a front side. An opposite side to the front side will be referred to as a rear side. A side of the cutting section 4 will be referred to as an upper side, and a side of the base section 2 will be referred to as a lower side. A groove extends in the frontward/rearward direction is formed in the upper face 21 for allowing a part of a circular saw blade 5 (described later) to be inserted thereinto.

A pair of right fence and left fence 22 are provided at the base section 2 for allowing the workpiece W to be in abutment therewith for positioning the workpiece W. A space is defined between the right and left fences 22.

The support section 3 includes a slide support part 31, a guard part 32, and a pivot support part 33. The slide support part 31 has a base end supported on the base section 2 by the pin 2A, and extends upward from the upper face 21. Therefore, the support section 3 can be tilted relative to the base section 2 about the pin 2A. Another end of the slide support part 31 is provided with a hold portion 31A for holding a slide bar 33B (described later). The guard part 32 extends frontward from the slide support part 31 at a position near the upper face 21.

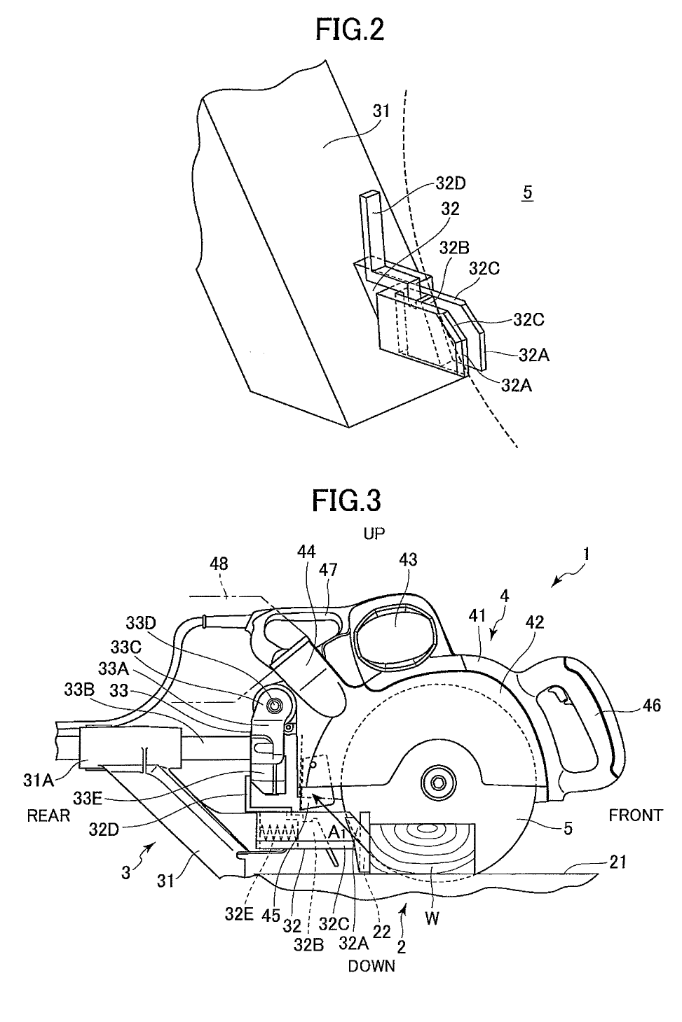

As shown in FIGS. 1 and 2, the guard part 32 includes abutment portions 32A, 32A, a slope portion 32B, a pair of wall portions 32C, 32C, an engagement member 32D, and a biasing member 32E. The guard part 32 is positioned behind the space between the right and left fences 22. The abutment portions 32A, 32A are adapted to receive a small cut wood piece passing through the space between the right and left fences 22 upon completion of cutting The abutment surfaces of the abutment portions 32A, 32A are in flush with the abutment surface of the fences 22.

As shown in FIG. 1, the slope portion 32B is situated on an extension line extending from an intersection line between the upper face 21 and the circular saw blade 5, the intersection line being provided when the circular saw blade 5 has pivotally moved to the lower side. The slope portion 32B is movable in a direction substantially parallel to the intersection line. The slope portion 32B has a slope face which obliquely crosses the extension of the intersection line.

Each wall portion 32C is provided at each lateral side of the slope portion 32B. The pair of wall portions 32C, 32C are always positioned on the two sides of the slope portion 32B irrespective of movement of the slope portion 32B in the frontward/rearward direction. The abutment portions 32A, 32A are positioned at front ends of the pair of wall portions 32C, 32C. Between the pair of wall portions 32C, 32C, the circular saw blade 5 is insertable. The engagement member 32D has an L-shaped configuration, and is connected to the slope portion 32B at a position thereabove. The engagement member 32D is located at a position where the engagement member 32D is engageable with a holder 33A (described later) when the pivot support part 33 moves rearward. The biasing member 32E such as a coil spring is provided behind the slope portion 32B. The slope portion 32B is biased frontward by the spring 32E.

The pivot support part 33 includes the holder 33A and the slide bar 33B extending rearward from the holder 33A. The slide bar 33B is slidably movably supported by the hold portion 31A of the slide support part 31. Accordingly, the pivot support part 33 is movable in the frontward/rearward direction, and is supported by the hold portion 31A through the slide bar 33B. The pivot support part 33 provides a first position where the pivot support part 33 has moved to the frontmost position, and provides a third position where the pivot support part 33 has moved to a rearmost position. An arm portion 33C having a pivot pin 33D is provided at an upper part of the holder 33A. The holder 33A pivotally movably supports the cutting section 4 by the pivot pin 33D, so that the cutting section 4 is moveable toward and away from the base section 2. A spring (not shown) is interposed between the arm portion 33C and the cutting section 4 for biasing the cutting section 4 away from the base section 2.

An engagement portion 33E is provided at a lower part of the holder 33A. The engagement portion 33E is engageable with the engagement member 32D for pressing the slope portion 32B rearward. The pivot support part 33 provides a second position where the engagement portion 33E is engaged with the engagement member 32D when the pivot support part 33 moves from the first position to the third position.

The cutting section 4 includes a frame 41, a saw cover 42, a motor 43, and the circular saw blade 5. The frame 41 has a rear end portion pivotally movably connected to the holder 33A by the pivot pin 33D. The circular saw blade 5 is rotatably supported to the frame 41, and has a rotation axis extending perpendicular to the frontward/rearward direction. The saw cover 42 is provided on the frame 41 so as to cover an upper part of the circular saw blade 5.

In a state where the cutting section 4 has been pivotally moved toward the upper face 21, a handle 46 is provided in front of the saw cover 42. The handle 46 serves as a grip when performing cutting. The handle 46 is provided with a switch 46A for controlling rotation of the motor 43. A cutting chip inflow part 44 is provided in the rear side of the saw cover 42. The inflow part 44 has an inlet opening through which cutting chips released from the workpiece W enters into the inflow parts 44.

A dust bag 48 is provided in communication with the inflow part 44 and at a position opposite to the inlet opening for accumulating cutting chips flowing from the inflow part 44. The motor 43 for driving the circular saw blade 5 is provided at an upper part of the frame 41. A handle 47 is provided near the motor 43 for transportation of the miter saw 1. A cutting chips guide member 45 made from rubber is provided at a lower part of the saw cover 42 and at a rear position thereof so as to cover a part of the circular saw blade 5. The cutting chips guide member 45 is adapted to guide travel of the cutting chips toward inside of the saw cover 42.

For cutting the workpiece W with the above-described miter saw 1, the cutting section 4 is first slid to the first position as a frontmost position and is pivotally moved downward. The switch 46A is then turned ON. In this state, the cutting section 4 is slid toward the third position as a rear position thereby cutting the workpiece W. As shown in FIG. 1, in a state where the saw blade 5 is cutting the upper face of the workpiece W, cutting chips flows into the saw cover 42 or the cutting chips guide member 45 as indicated by an arrow A. Cutting chips thus flowing in the saw cover 42 is introduced into the inflow part 44 and is accumulated in the dust bag 48.

Next, as shown in FIG. 3 where the circular saw blade 5 cuts a rear end face of the workpiece W and the cutting section 4 is moved rearward to the second position where the engagement portion 33E contacts the engagement member 32D. In this case, cutting chips flows into the cutting chips guide member 45 as indicated by an arrow A1 and is collected into the dust bag 48 via the inflow part 44. If the pivot support part 33 moves past the second position toward the third position, the slope portion 32B moves rearward in interlocking relation with the cutting section 4.

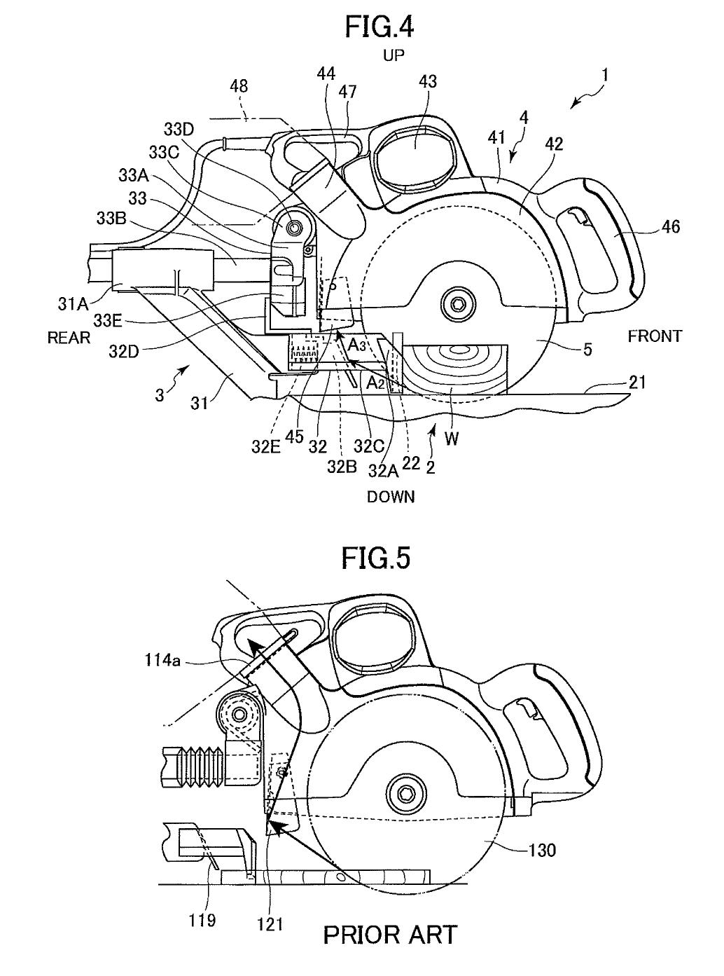

The cutting section 4 further moves rearward and the circular saw blade 5 cuts a lower part of the rear end face of the workpiece W as shown in FIG. 4. In this case, cutting chips is discharged from the circular saw blade 5 in a direction indicated by an arrow A2. If cutting chips is discharged only in the direction of arrow A2, neither the saw cover 42 nor the cutting chips guide member 45 exists on an extension of the arrow A2. However, cutting chips collides with the slope portion 32B and rebounds in a direction indicated by an arrow A3 since a slope face of the slope portion 32B exists on an extension of the arrow A2.

The saw cover 42 and the cutting chips guide member 45 exist on the path indicated by the arrow A3. Therefore, cutting chips can flow in the saw cover 42 and can be collected into the dust bag 48 via the inflow part 44. If cutting chips flows in the saw cover 42 along a path denoted by the arrows A2 and A3, this path length is longer than another path length denoted by the arrow A in FIG. 1. This leads to an assumption that cutting chips may be discharged outside the saw cover 42 in the middle of the path. However, the slope portion 32B in FIG. 4 is interposed between the pair of wall portions 32C, 32C, so that leakage of the cutting chips can be prevented. Further, a locally unshielded path length in FIG. 4 from an upper edges of the wall portions 32C to the lower edge of the saw cover 42 with respect to the path A3 is shorter than a locally unshielded path length between the upper surface of the workpiece W and the lower edge of the saw cover 42 with respect to the path A of FIG. 1. Therefore, even when the circular saw blade 5 cuts a lower part of the rear end face of the workpiece W, cutting chips can be appropriately collected into the dust bag 48.

Further, when the pivot support part 33 is at a position between the second and third positions, the slope portion 32B is biased toward the first position, i.e., toward the front side by the coil spring 32E. Therefore, when the slope portion 32B is pressed toward the third position by the pivot support part 33 via the engagement member 32D, the slope portion 32B always moves integrally with the pivot support part 33. Therefore, the distance between the slope portion 32B and the saw cover 42 is always maintained constant during movement of the pivot support part 33 from its second position to the third position. Besides, the wall portion 32C is positioned on each side of the slope portion 32B at all times, so that cutting chips can be stably flowed into the saw cover 42.

In the miter saw 1, the support section 3 and the cutting section 4 are laterally tiltably movable relative to the base section 2 through the pin 2A. Even during the tilting posture, the cutting section 4 is movable frontward/rearward and cutting chips can be accumulated into the dust bag 48.

While the invention has been described in detail and with reference to specific embodiment thereof, it would be apparent to those skilled in the art that various changes and modifications may be made therein without departing from the scope of the invention. For example, the base section can be provided with a turntable on which the support section supporting the cutting section is provided. Further, in the above-described embodiment, the guard part 32 is provided at the slide support part 31. However, the guide part 32 can be provided at the base section 4.

What is claimed is:

1. A miter saw comprising:
a base section on which a workpiece is mountable;
a cutting section supporting a circular saw blade and defining an inflow part into which cutting chips are to be introduced, the circular saw blade and the base section defining an intersection line;
a support section provided to the base section and supporting the cutting section, the support section comprising a pivot support part pivotally supporting the cutting section for moving the cutting section toward and away from the base section; and a slide support part extending from the base section and slidably supporting the pivot support part for moving the pivot support part in a direction of the intersection line; and
a slope portion positioned between the support section and the circular saw blade and in alignment with the intersection line and movable in the direction of the intersection line, the slope portion having a deflection surface at a position confrontable with the circular saw blade and configured to direct the cutting chips toward the inflow part.

2. The miter saw as claimed in claim 1, further comprising a guard part provided at one of the base section and the slide support part and positioned in alignment with the intersection line, the guard part comprising an engagement member connected to the slope portion and engageable with the pivot support part when the pivot support part is moved to a predetermined position, whereby the slope portion is moved in interlocking relation with the movement of the pivot support part in the direction of the intersection line.

3. The miter saw as claimed in claim 2, wherein the pivot support part is movable past an intermediate second position between a first position most remote from the slope portion and a third position closest to the slope portion, the engagement member being out of engagement from the pivot support part when the pivot support part is at a position between the first position and the second position, and the engagement member being engaged with the pivot support part when the pivot support part is at a position between the second position and the third position, the intermediate second position being the predetermined position.

4. The miter saw as claimed in claim 2, wherein the pivot support part comprises:
a slide bar slidably supported by the slide support part and movable in the direction of the intersection line; and,
a holder supported on the slide bar for pivotally movably supporting the cutting section, the engagement member being engageable with the holder.

5. The miter saw as claimed in claim 2, wherein the slope portion has a first side and a second side each extending in the direction of the intersection line; and
wherein the guard part further comprises a pair of wall portions including a first wall portion always positioned at the first side and a second wall portion always positioned at the second side regardless of the movement of the slope portion, the first side and the second side being in sliding relation to the first wall portion and the second wall portion, respectively.

6. The miter saw as claimed in claim 5, wherein the pair of wall portions extends from one of the base section and the slide support part in the direction of the intersection line, the pair of wall portions having free ends abuttable against the workpiece.

7. The miter saw as claimed in claim 5, wherein the guard part further comprises a biasing member that bias the slope portion toward the circular saw blade in the direction of the intersection line.
